(19) United States
(12) Patent Application Publication
(10) Pub. No.: US 2017/0351536 A1
(43) Pub. Date: Dec. 7, 2017

(54) PROVIDE HYPERVISOR MANAGER NATIVE API CALL FROM API GATEWAY TO HYPERVISOR MANAGER

(71) Applicant: HEWLETT PACKARD ENTERPRISE DEVELOPMENT LP, HOUSTON, TX (US)

(72) Inventors: Chandra Kamalakantha, Plano, TX (US); Parag Doshi, Marietta, GA (US); Steven Marney, Lake Orion, MI (US)

(21) Appl. No.: 15/171,768

(22) Filed: Jun. 2, 2016

(51) Int. Cl. G06F 9/455; G06F 9/54

(52) U.S. Cl. CPC G06F 9/45558; G06F 9/543; G06F 2009/45595; G06F 2009/45583

(57) ABSTRACT

Examples include provision of a hypervisor manager native API call from an API gateway to a hypervisor manager. Some examples include determination, with the API gateway and based on at least one restriction not enforced by the hypervisor manager, whether a requesting entity associated with the hypervisor manager native API call is authorized to cause an action that is requested in the hypervisor manager native API call. Such examples may involve provision of the hypervisor manager native API call from the API gateway to the hypervisor manager in response to a determination that the action is authorized.

### BACKGROUND

A cloud computing environment may enable a consuming entity to utilize a computing device to access computing resources that are remote from the computing device over at least one computer network. In some examples of a cloud computing environment, the remote computing resources may be provided to the consuming entity through layer(s) of virtualization. For example, a cloud computing environment may provide the consuming entity with access to a virtual machine (VM) executing on remote hardware under the management of a hypervisor that virtualizes underlying physical hardware resources (e.g., hardware processing resource(s), storage resource(s), and networking resource(s)).

### BRIEF DESCRIPTION OF THE DRAWINGS

The following detailed description references the drawings, wherein:

FIG. 1 is a block diagram of an example computing device comprising instructions to at least partially implement an application programming interface (API) gateway to provide a hypervisor manager native API call to a hypervisor manager;

FIG. 2 is a block diagram of an example cloud computing environment including an API gateway to provide, to a hypervisor manager, a modified request including a received hypervisor manager native API call;

FIG. 3 is a block diagram of an example cloud computing environment including an API gateway to provide network and storage native API calls to network and storage managers, respectively;

FIG. 4 is a flowchart of an example method of an API gateway including forwarding a hypervisor manager native API call to a hypervisor manager; and

FIG. 5 is a flowchart of an example method of an API gateway including determining whether a requesting entity is authorized to cause an action associated with a hypervisor manager native API call received by the API gateway.

### DETAILED DESCRIPTION

In some examples, a cloud service provider may provide a consuming entity with access to virtualized computing resources (e.g., at least one of virtualized computing, networking, and storage resources) implemented in a cloud computing environment (or “cloud environment” herein) on underlying physical computing resources. In some examples, a cloud service provider may provide the consuming entity with access to the virtualized computing resources provided by one type of cloud environment and one vendor implementation of that cloud environment. In other examples, a “hybrid” cloud service may provide interface(s) through which a consuming entity (or client) may access and utilize any of multiple different types of cloud environments (e.g., public cloud, private cloud, virtual private cloud, etc.), any of multiple different cloud implementations from different vendors (e.g., VMware®, Amazon Web Services™ (AWS), MICROSOFT AZURE, HPE HELION EUCALYPTUS, etc.), or a combination thereof. In examples described herein, a cloud computing environment may include a single-vendor and single cloud type implementation, or may be a hybrid cloud computing environment including multiple different types of cloud environments, multiple different cloud implementations from different vendors, or a combination thereof.

In some examples, a cloud service provider may provide interface(s) through which a client may access resources implemented by underlying cloud computing environment(s). In such examples, the interface(s) may receive requests from the client in an abstracted format that is not native to any underlying cloud environment, and the interface(s) may handle cloud- or vendor-specific communication with the underlying cloud environments on behalf of the client. In some examples, a cloud computing environment may include a hypervisor manager to manage various resources of the cloud computing environment, such as hypervisor(s) and virtual machine(s) managed by those hypervisors. In such examples, a client legacy application or system may be programmed to communicate directly with a hypervisor manager of a specific type or specific vendor using application programming interface (API) calls that are native to that type of hypervisor manager. As such, enabling the legacy application or system to utilize the cloud service provided interface may involve reprogramming the legacy application or system to use the abstracted format of the interface, for example. In addition, limiting a client or consuming entity to use of the abstracted format of the interface(s) may limit the flexibility with which a consuming entity may interact with underlying cloud environment(s) and implementation(s) provided by the hybrid cloud service.

However, providing consuming entities of a cloud or hybrid cloud service with access to native APIs supported by hypervisor managers may be very problematic, as hypervisor managers and their native APIs do not provide or support many of the restriction(s) or protection(s) involved in safely providing a cloud or hybrid cloud service, such as restriction(s) or protection(s) to account for multi-tenancy, limited capacity, and the like, for example. Direct access to a hypervisor manager via its native APIs is often provided within a data center of a single client presumed to have full access to all resources managed by the hypervisor manager, so a hypervisor manager and its native APIs may not provide the above-described restriction(s) or protection(s) involved in providing virtual resources in a cloud or hybrid cloud service. Additionally, modifying a hypervisor manager, its native API, or both, to accommodate such restriction(s) and protection(s) for a cloud environment may be very difficult, as it may involve causing the vendor of a hypervisor manager to make such changes in their products. Further, even if such changes were made, it may not be advantageous for legacy systems and applications, as using modified hypervisor manager instance(s) and modified native API(s) would still likely involve modifying legacy systems and applications, as described above in relation to using the abstracted format of the cloud environment interface.

To address these issues, examples described herein provide an API gateway for a cloud computing environment that enables a client to interact with an underlying hypervisor manager of the hybrid cloud environment via hypervisor manager native API calls. In examples described herein, the API gateway may intercept hypervisor manager native API calls so that requests of those API calls may be validated in relation to various protection(s) and restriction(s) provided by a cloud service provider for the cloud computing environment (e.g., for multi-tenancy, capacity usage restrictions, etc.) before the native API calls are passed to underlying hypervisor manager instance(s) of the cloud computing environment behind the API gateway. In such examples, these restriction(s) and protection(s) are provided and validated without modification of either the hypervisor manager(s) or their native APIs, and the restriction(s) and protection(s) are provided and validated in a manner that is transparent to the consuming entity. In this manner, the native API calls may be safely utilized in the cloud computing environment and, for example, without modification of legacy system(s) or application(s) utilizing those native API calls.

In this manner, examples described herein may provide access to hypervisor manager native API calls in a cloud computing environment (e.g., a hybrid cloud computing environment), while the API gateway transparently provides protections around the API calls related to providing a multi-tenant cloud service, which are not provided by the hypervisor managers themselves. Such examples may enable legacy applications to utilize hypervisor manager native API calls while still providing protections for a multi-tenant cloud or cloud environment, for example.

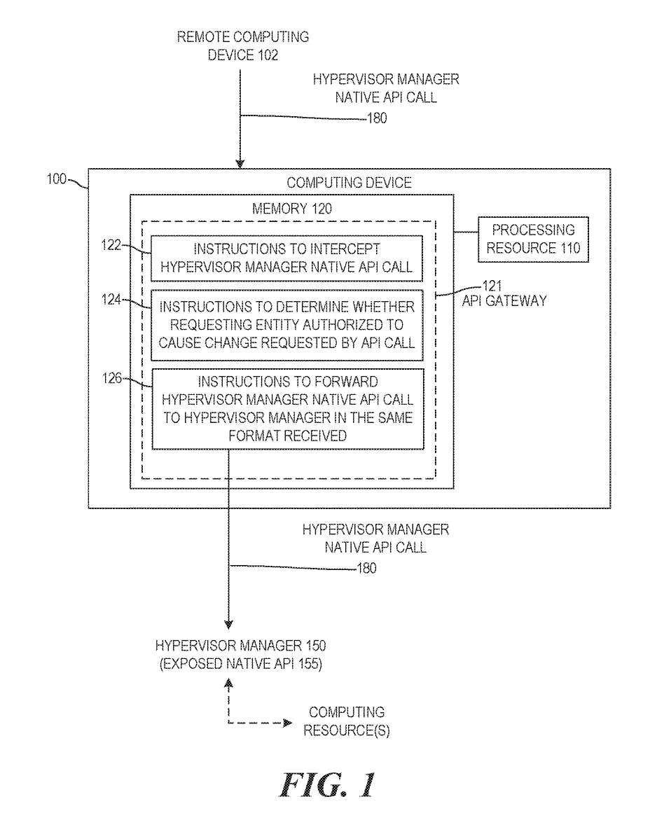

Referring now to the drawings, FIG. 1 is a block diagram of an example computing device 100 comprising instructions to at least partially implement an API gateway 121 to provide a hypervisor manager native API call 180 to a hypervisor manager 150 exposing a native API 155 of hypervisor manager 150. Computing device 100 includes a processing resource 110 and a machine-readable storage medium 120 comprising (e.g., encoded with) instructions 122, 124, and 126 that are executable by processing resource 110 to at least partially implement API gateway 121, including implementing functionalities of API gateway 121 described herein in relation to FIG. 1. In some examples, storage medium 120 may include additional instructions (e.g., of API gateway 121). In other examples, functionalities described herein in relation to instructions 122, 124, and 126, and any additional instructions described herein in relation to storage medium 120, may be implemented at least in part in electronic circuitry (e.g., via engines comprising any combination of hardware and programming to implement the functionalities of the engines, as described below).

In the example of FIG. 1, instructions 122 of API gateway 121 may intercept an API call 180 native to a hypervisor manager of a cloud computing environment, which may be referred to herein as a “hypervisor manager native API call”. The hypervisor manager native API call 180 may be received at the API gateway from a remote computing device 102 associated with a requesting entity (e.g., a client, customer, etc.) attempting to access resource(s) of a cloud computing environment provided by a cloud service provider, for example. In such examples, API gateway 121 may serve as a front-end interface for the cloud computing environment through which requesting entities may access other computing resource(s) of the cloud computing environment.

In examples described herein, a hypervisor manager (or instance of a hypervisor manager of a given type) may expose an API through which actions of the hypervisor manager may be invoked. The API exposed by a hypervisor manager may be referred to herein as a “native” API of the hypervisor manager and, in examples described herein, an API call that is “native” to the hypervisor manager may be an API call having a format and API signature that is valid to invoke at least one action of the hypervisor manager via the API exposed by the hypervisor manager (i.e., the native API of the hypervisor manager), when the API call is provided to the hypervisor manager.

In some examples, a native API exposed by a hypervisor manager may define a plurality of API functions (or “functions” herein) that may be invoked via API calls (i.e., hypervisor manager native API calls). Each such API function may be called, via an appropriate hypervisor manager native API call, to cause the hypervisor manager to perform one or a plurality of different actions. In such examples, a function may be called differently (e.g., with different valid parameters) to cause different actions that may be performed via that function.

In some examples, a native API exposed by a hypervisor manager may, for each function defined by the native API, define a function name for invoking the corresponding function exposed by the native API, and a collection of one or more parameters for the function exposed via the function name, the parameters having a defined number and a defined order, and each having a respective type defined by the native API for the function exposed via the function name.

As noted above, in the example of FIG. 1, instructions 122 of API gateway 121 may intercept a hypervisor manager native API call 180 from a remote computing device 102. In such examples, to intercept a hypervisor manager native API call 180, instructions 122 may acquire the hypervisor manager native API call 180 (e.g., via a network interface of computing device 100) and identify the API call 180 as a hypervisor manager native API call, which may trigger a validation process associated with the identified hypervisor manager native API call that may delay the provision of the hypervisor manager native API call 180 to the appropriate hypervisor manager until after the validation successfully completes.

In such examples, instructions 122 may acquire (e.g., receive, retrieve, etc.) API call 180 via a network interface of computing device 100 as part of a request or request packet that includes the API call 180 as well as other information, such as another header (e.g., a request header) discussed further below. After acquiring the request including API call 180, instructions 122 may identify the API call 180 as a hypervisor manager native API call. For example, instructions 122 may compare the signature of API call 180 (e.g., the function name and the number, order, and types of the parameters of the API call) to other API call signature information (e.g., stored in memory 120, elsewhere on computing device 100, or outside of computing device 100) for use in identifying hypervisor manager native API calls. Instructions 122 may compare the acquired API call 180 to the other API call signature information using direct comparison, pattern matching, or any other suitable technique to determine whether API call 180 is a hypervisor manager native API call. In some examples, the other API call signature information may be web service definition language (WSDL) information of API gateway 121 or computing device 100 that indicates what API calls are available to be called via API gateway 121, any other information that may indicate signatures of hypervisor manager native API calls (e.g., via pattern matching or any other suitable comparison technique), or a combination thereof.

In the example of FIG. 1, in which API call 180 is a hypervisor manager native API call 180, instructions 122 may identify API 180 as a hypervisor manager native API call, as described above, which may trigger a validation process associated with the identified hypervisor manager native API call that may delay the provision of the hypervisor manager native API call 180 to the appropriate hypervisor manager until after the validation successfully completes.

In some examples, the identification of API call 180 as a hypervisor manager native API call may trigger the determination process of instructions 124, which may include performing a series (or pipeline) of one or more validation checks based on the particular hypervisor manager native API call 180 identified by instructions 122. For example, instructions 124 may perform the series of validation check(s) in response to instructions 122 identifying API call 180 as a hypervisor manager native API call. In some examples, instructions 124 may perform different series (or pipelines) of validation checks for different types of hypervisor manager native API calls (e.g., hypervisor manager native APIs call with different signatures), respectively. In such examples, in response to instructions 122 identifying API call 180 as a hypervisor manager native API call 180 (e.g., via the signature of API call 180), instructions 124 may identify and perform the particular series (or pipeline) of validation checks associated with the particular API signature of hypervisor manager native API call 180.

In examples described herein, the series of validation checks performed by instructions 124 of API gateway 121 may be performed as part of the enforcement, by API gateway 121, of restriction(s) that are not enforced by hypervisor manager 150. For example, API gateway 121 may enforce restrictions related to safely providing access to hypervisor manager native API calls in a multi-tenant cloud environment where each tenant (e.g., customer, organization, etc.) is to be prevented from accessing or performing actions on computing resources assigned exclusively to another tenant. Hypervisor managers do not provide multi-tenancy restrictions to prevent tenants from accessing the computing resources assigned to other tenants, but may instead enable any entity able to log in to the hypervisor manager to perform any valid action. As an example, API gateway 121 may enforce multi-tenancy restrictions with regard to hypervisor manager native API calls by instructions 124 determining whether a requesting entity associated with hypervisor manager native API call 180 is authorized to cause a change, to a computing resource managed by the hypervisor manager 150, that is requested in hypervisor manager native API call 180.

In some examples, multi-tenancy related validation checks performed by instructions 124 of API gateway 121 may relate to whether a requesting entity is authorized to perform requested action(s) on a given computing resource. In such validation checks, each of the requesting entity and the computing resource may be evaluated based on one or more of the identity, attributes, associations (e.g., role(s), membership(s), etc.), and the like, of the requesting entity or computing resource. For example, a requesting entity may have a particular identity, one or more roles assigned to it, one or more memberships assigned to it (e.g., membership for a particular tenant, sub-tenant, project, etc.), one or more attributes, and the like, any of which may be used in an evaluation of whether the requesting entity authorized to perform the requested action(s) on the given computing resource.

In some examples, a computing resource associated with a request may also have one or more different attributes, associations (e.g., presence on or in an individual physical or virtual resource or grouping of resources), and the like. For example, a computing resource may have ownership attribute(s) (e.g., indicating an entity owning the resource), and may be associated with a hierarchy of other computing resources, which may each have their own attributes. For example, a virtual machine (VM) may be a resource in a cloud computing environment, and may be owned by a particular entity. In such examples, the VM may also be part of a particular folder, the VM and the folder may be implemented on a particular host, such as a physical server having its own attribute(s). In such examples, the host may be a member of a particular cluster of physical hosts, where the host and its associated cluster are part of a particular data center. In determining whether a requesting entity may perform the requested action(s) on a computing resource, instructions 124 may make the determination based on any combination of the identity, attribute(s), association(s), and the like, of the requesting entity and any of the identity, attribute(s), and association(s) of the computing resource (or any other virtual or physical computing resource to which it is associated).

As an example, instructions 122 may intercept a hypervisor manager native API call 180 from a user with a user identity “USER1”, requesting a resize operation on a virtual machine with an identifier of “VM-101”, and instructions 124 may determine the series of validation checks to perform, as described above. As an example, instructions 124 may perform a validation check to determine whether the particular user identity USER1 (i.e., the requesting entity) has permission to resize the virtual machine VM-101 (i.e., the computing resource).

As another example, instructions 124 may perform a validation check to determine whether the particular user identity USER1 has access to a folder PROJ1 in which virtual machine VM-101 resides. In some examples, instructions 124 may determine that user identity USER1 has access to the folder PROJ1 when user identity USER1 is assigned to a particular project where all users assigned to that project have access to PROJ1. In other examples, user identity USER1 may be authorized to resize virtual machine VM-101, but instructions 124 may determine that user identity USER1 does not have access to folder PROJ1 (e.g., because USER1 is not assigned to a project, tenant, role, etc., provided access to folder PROJ1.)

In a similar manner, in some examples, instructions 124 may determine whether user identity USER1 (e.g., based on one or more of the user identity itself, its attributes, associations, or the like) is authorized to access one or more of: the physical host that is hosting virtual machine VM-101, a cluster of hosts to which the physical host belongs, a data center including the physical host and the cluster, and the like. As an example, instructions 124 may determine that a tenant to which user identity USER1 belongs does have access to the particular data center in which virtual machine VM-101 is hosted, but that tenant does not have access to the cluster of hosts on which virtual machine VM-101 is hosted. In some examples, other types of computing resource associations that may be used for validation checks as described above may include resource pools to which computing resources may belong and zones defined for virtual machine placement.

In addition or as an alternative to validating whether the entity has access to the particular resource, instructions 124 may check whether the requesting entity is authorized to perform the requested action in relation to the computing resource (e.g., is USER1 able to resize VMs on a given cluster, etc.). As another example, the requested action may be creating a virtual machine of a particular type or using a particular image, and instructions 124 may check whether the requesting entity is authorized to create a VM of that particular type or using that particular image. In some examples, the computing resource may be a storage or networking resource, and instructions 124 may perform similar validation check(s) for those computing resources. For example, for a storage resource, instructions 124 may determine whether the requesting entity is authorized to access a particular data store that would be accessed by the requested action. As another example, for a networking resource, instructions 124 may determine whether the requesting entity is authorized to perform an action on a particular internet protocol (IP) address range that would be impacted by the requested action. Although various examples of validation checks are described herein for explanatory purposes, instructions 124 may perform any of the validation checks described above, additional validation checks, different validation checks, or any suitable combination thereof, as part of a series (or pipeline) of validation checks. In some examples, one or more of the validation checks may be based on policies stored locally on computing device 100, in one or more remote information source(s), or a combination thereof. In some examples, such policies may relate to data provenance, physical or virtual co-location of computing resources, or any other suitable aspect, requirement, preference, or the like.

In examples described herein, each of the validation checks performed by instructions 124 is based on at least one restriction imposed and enforced by API gateway 121 and not imposed, enforced, or checked by hypervisor manager 150. For example, as described above, API gateway 121 may impose and enforce various restrictions regarding which requesting entities may access or perform particular actions on which computing resources, based on entity and resource identities, attributes, associations, and the like. As a simple example, API gateway 121 may allow a user identity USER1 to use a hypervisor manager native API call to resize a virtual machine VM-101 managed by hypervisor manager 150, but may restrict user identity USER1 from using a hypervisor manager native API call to resize a virtual machine VM-102 managed by hypervisor manager 150. However, hypervisor manager 150 may not impose or enforce any such restriction to prevent USER1 from resizing VM-102. Rather, hypervisor manager 150 may natively enable any action enabled by hypervisor manager native API 155 to be performed by any entity able to log in to hypervisor manager 150.

In examples described herein, a computing resource may be any virtual computing resource (e.g., VM, VM folder, hypervisor, virtual processing resource, virtual networking resource, virtual storage resource), or physical computing resource(s) utilized to implement a virtual computing resource (e.g., physical host, resource pool(s), cluster of physical hosts, data center, or any physical computing, networking, or storage resources of host(s)). In examples described herein, an “entity” may be any organizational, individual, or programmatic consumer of computing resource(s) in a cloud computing environment that is associated with one or more identities in the cloud computing environment. For example, a requesting entity may be a particular tenant or sub-tenant in a multi-tenant cloud computing environment, or an individual user identity that may be associated with a particular tenant or sub-tenant in a multi-tenant cloud computing environment. In some examples, a programmatic consumer of computing resources may be an application that may, for example, have an application user identity (which may have associations, as described above, such as being associated with a particular tenant or sub-tenant, etc.).

In the example of FIG. 1, instructions 124 of API gateway 121 may determine whether a requesting entity associated with hypervisor manager native API call 180 is authorized to cause an action on (e.g., cause a change to) a computing resource managed by the hypervisor manager 150, wherein the action (e.g., change) is requested in the hypervisor manager native API call. In the example of FIG. 1, this determination may be based on at least one restriction not enforced by the hypervisor manager.

In some examples, as part of the authorization determination, instructions 124 may determine a requesting entity associated with the hypervisor manager native API call 180 based on user information provided with API call 180. For example, instructions 122 may acquire API call 180 as part of a request or request packet that includes requestor information in header information of the request, outside of the API call 180. As an example, the requestor information may include authentication information (e.g., an authentication or session identifier, cookie, token, or the like), which instructions 124 may use to determine the requesting entity. For example, instructions 124 may access a repository maintained by API gateway 121 (e.g., stored in memory of computing device 100 or elsewhere), in which session information is associated with user identities. Instructions 124 may then use the determined user identity associated with the session information for the validation check(s).

In some examples, as part of the authorization determination, instructions 124 may determine a computing resource that is a subject of the validation check(s) from the content of the API call 180, which may include an identifier for the computing resource. For example, in the example API call 180 described above, the API call 180 may include the virtual machine identifier VM-101 as a parameter, and instructions 124 may determine, by inspecting API call 180, that virtual machine VM-101 is a computing resource that is a subject of the validation checks. In some examples, as part of the authorization determination, instructions 124 may determine the series (or pipeline) of validation check(s) to perform as part of the authorization determination, based on the signature of hypervisor manager native API call 180, as described above. In such examples, instructions 124 may perform the determined series (or pipeline) of validation check(s). When performing the validation check(s), instructions 124 may access remote information sources external to API gateway 121 and computing device 100, to obtain and use current information regarding the identities, attributes, associations, and the like, of the requesting entity and the computing resource. These remote information sources may include one or more of resource management database(s) or system(s) (e.g., indicating permissions, attributes, associations, or the like, for entities and computing resources), a cloud service provider system (e.g., accessible via a cloud service provider API), an authentication system, and the like, each of which may be remote from API gateway 121 and computing device 100. Such validation check(s) described above which depend on permissions granted in a cloud computing environment based on identities, attributes, associations, etc., of entities and computing resources may be referred to herein as permissions-related validation check(s).

In the example of FIG. 1, instructions 124 may determine that the requesting entity associated with hypervisor manager native API call 180 is authorized to cause the requested action on (e.g., cause the requested change to) the computing resource managed by the hypervisor manager 150 when instructions 124 determine that all of the validation check(s) of the determined series (or pipeline) were passed successfully. In such examples, instructions 124 may determine that the requesting entity associated with hypervisor manager native API call 180 is not authorized to cause the requested action on (e.g., cause the requested change to) the computing resource managed by the hypervisor manager 150 when instructions 124 determine that at least one of the validation check(s) of the determined series (or pipeline) failed.

In examples in which resource quotas are enforced, instructions 124 may perform capacity-related validation check(s). For example, when the requesting entity has the appropriate permissions to perform a requested action, instructions 124 may also perform validation check(s) to determine whether the requesting entity has the capacity available (before exceeding its quota) to perform the action. Such checks may be referred to herein as capacity-related validation check(s). For example, as part of the series (or pipeline) of validation checks for a requested action to resize a virtual machine to give it more compute resource and more memory, instructions 124 may determine whether the requesting entity has capacity remaining of its assigned quota of compute and memory resources to complete the request without exceeding the quota. If so, then instructions 124 may determine that the validation check(s) pass successfully, which may contribute to a determination that the request is authorized. If not, then instructions 124 may determine that the request is not authorized. In such examples, respective quotas may be assigned to a user identity and to any other group or class with which the user identity is associated (e.g., tenant, sub-tenant, group, role, etc.). In some examples, the capacity check may fail if the capacity check fails for any of the quotas, and may pass if the check passes for all of the quotas. In examples described herein, any of these capacity checks may fail based on assigned quotas independent of whether the hypervisor manager 150 has access to sufficient capacity to fulfill the request (i.e., even when hypervisor manager 150 has sufficient available resources to fulfill the request). In examples described herein, each capacity validation check performed by instructions 124 is based on at least one capacity (i.e., quota) restriction imposed and enforced by API gateway 121 and not imposed, enforced, or checked by hypervisor manager 150. For example, hypervisor manager 150 may not impose or enforce capacity or quota restrictions in relation to particular entities and their roles and associations.

In some examples, instructions 124 may perform orchestration-related validation check(s) to determine whether the requested action may lead to undesirable conditions (e.g., panic conditions) in the cloud computing environment. In such examples, instructions 124 may determine that the requesting entity is not authorized to perform the requested action when instructions 124 determine that the requested action may lead to undesirable conditions (e.g., panic conditions) in the cloud computing environment. In such examples, each of these cloud condition validation checks performed by instructions 124 is based on at least one cloud condition restriction imposed and enforced by API gateway 121 and not imposed, enforced, or checked by hypervisor manager 150. For example, hypervisor manager 150 may not impose or enforce cloud condition restrictions to prevent actions that may lead to undesirable conditions in a cloud computing environment.

In some examples, another restriction imposed and enforced by API gateway 121, and not imposed or enforced by hypervisor manager 150, may be restrictions regarding which actions of an API function exposed by the native API 155 of hypervisor manager 150 may be invoked via a hypervisor manager native API call provided to hypervisor manager 150 via API gateway 121. Checks related to such restrictions may be referred to herein as restricted-action related validation checks. For example, native API 155 may define an API function with a function name “ReconfigVM_Task” that may perform a plurality of actions (e.g., a virtual machine resize action, a virtual machine renaming action, etc.) depending on how the function is called (e.g., the API signature of the hypervisor manager native API call invoking the ReconfigVM_Task function). In some examples, API gateway 121 may impose and enforce restrictions such that API gateway may permit the resize action of the API function “ReconfigVM_Task” to be invoked via a hypervisor manager native API call provided to the hypervisor manager 150 via API gateway 121, but may prevent the rename action of the API function “ReconfigVM_Task” to be invoked via a hypervisor manager native API call provided to the hypervisor manager 150 via API gateway 121.

In such examples, instructions 124 of API gateway 121 may determine whether a hypervisor manager action exposed by the hypervisor manager via the API and requested in hypervisor manager native API call 180 is an action permitted by API gateway 121 to be invoked via a hypervisor manager native API call provided via API gateway 121. Instructions 124 may perform this validation check independent of any permissions associated with the requesting entity and the computing resource. For example, when hypervisor manager native API call 180 comprises a call to the “ReconfigVM_Task” API function with content (e.g., parameter(s)) to invoke the virtual machine resize action exposed by the native API 155 via the “ReconfigVM_Task” API function, then instructions 124 may determine that the hypervisor manager action (i.e., resize) exposed by hypervisor manager 150 via the native API 155 and requested in hypervisor manager native API call 180 is an action permitted by API gateway 121 to be invoked via a hypervisor manager native API call provided via API gateway 121, and as such may determine that this validation check is passed successfully.

In other examples, when hypervisor manager native API call 180 comprises a call to the “ReconfigVM_Task” API function with content (e.g., parameter(s)) to invoke, for example, the virtual machine rename action for exposed by the native API 155 via the “ReconfigVM_Task” API function, then instructions 124 may determine that the hypervisor manager action (i.e., rename) exposed by hypervisor manager 150 via the native API 155 and requested in hypervisor manager native API call 180 is not an action permitted by API gateway 121 to be invoked via a hypervisor manager native API call provided via API gateway 121, regardless of any permissions associated with the requesting entity and the computing resource, and as such may determine that this validation check fails. Although one example of actions of an API function permitted or restricted by API gateway 121 is described above for explanatory purposes, any suitable number and combination of actions may be restricted or permitted by API gateway 121 as described above, for each of one or more API functions of a native API 155 of a hypervisor manager 150. In some examples, API gateway 121 may store suitable information to enable instructions 124 to identify permitted and restricted actions as described above (e.g., via pattern matching, or any other suitable technique).

In examples described herein, restriction(s) enforced by an API gateway that are not enforced by the hypervisor manager, as described herein, may relate to restrictions on a particular requesting entity causing particular action(s) via the hypervisor manager (e.g., based on factor(s) described above) where the API gateway may permit the requesting entity to cause other action(s) via the hypervisor manager. As such, in examples described herein, restriction(s) enforced by an API gateway that are not enforced by the hypervisor manager may be much more fine-grained and flexible than a login restriction which may permit a requesting entity to cause any valid action via the hypervisor manager when the entity is able to log in to the hypervisor manager and which may prevent the requesting entity from causing any action via the hypervisor manager on a computing resource managed by hypervisor manager when the requesting entity is not able to log in to the hypervisor manager. Rather, examples described herein may permit a requesting entity to cause particular action(s) via a hypervisor manager and restrict the requesting entity from causing other particular action(s) via the hypervisor manager based on, for example, one or more permissions-related validation check(s), capacity-related validation check(s), orchestration-related validation check(s), restricted-action related validation check(s), and the like, or a combination thereof.

In the example of FIG. 1, based on any suitable combination of one or more validation check(s) described herein, instructions 124 of API gateway 121 may determine, based on at least one restriction not enforced by the hypervisor manager, whether a requesting entity associated with the hypervisor manager native API call 180 is authorized to cause an action on (e.g., cause a change to) a computing resource managed by hypervisor manager 150, where the action is requested in the hypervisor manager native API call 180. In such examples, in response to a determination that all validation check(s) of the determined series (or pipeline) of validation check(s) have passed, instructions 124 may determine that the requesting entity associated with the hypervisor manager native API call 180 is authorized to perform the requested action on the computing resource managed by hypervisor manager 150.

In such examples, based on a determination by instructions 124 that the requesting entity is authorized to perform the requested action on the computing resource managed by hypervisor manager 150, instructions 126 may forward the hypervisor manager native API call 180 from the API gateway to the hypervisor manager in the same format and with the same API signature as when it was received at the API gateway. In some examples, to forward the API call 180, instructions 126 may access API call 180 from memory of computing device 100 (e.g., memory 120), and provide the API call 180 to the hypervisor manager 150 (e.g., via a network interface of computing device 100).

In some examples, to forward the API call 180, instructions 126 may determine a location of the hypervisor manager 150 (i.e., the hypervisor manager instance) to which the API call 180 is to be provided, and provide the API call 180 to the hypervisor manager 150 at the determined location. For example, API gateway 121 may hide an actual location identifier (e.g., uniform resource locator (URL)) of hypervisor manager 150 from requesting entities (e.g., as a protection for the hypervisor manager 150 in a multi-tenant cloud computing environment, etc.). In such examples, instructions 126 of API gateway 121 may provide a spoofed hypervisor manager location identifier to a requesting entity prior to receipt of the API call 180 by API gateway 121.

In some examples, instructions 122 may intercept hypervisor manager native API call 180 as part of a request from a requesting entity, where the request comprises the hypervisor manager native API call 180 and other information, such as the spoofed hypervisor manager location identifier for the requesting entity. In some examples, the spoofed hypervisor manager location identifier for the requesting entity may be included in a header of the request and the API call 180 may be included in a body of the request. In such examples, based on a determination by instructions 124 that the requesting entity is authorized to perform the requested action on the computing resource managed by hypervisor manager 150, instructions 126 may obtain an actual (i.e., valid) hypervisor manager location identifier for hypervisor manager 150 (as described above). In such examples, instructions 126 may replace the spoofed hypervisor manager location identifier in the request with the obtained valid hypervisor manager location identifier to generate a modified request including hypervisor manager native API call 180 and the valid hypervisor manager location identifier (separate from the API call 180). In such examples, instructions 126 may provide the modified request from API gateway 121 to hypervisor manager 150 at the location identified by the valid hypervisor manager location identifier (e.g., URL), where the modified request includes the valid hypervisor manager location identifier, and the hypervisor manager native API call 180 in the same format and with the same API signature as when the API call 180 was received by API gateway 121. For example, as described below, the cloud computing environment may include multiple instances of a hypervisor manager of a given type. In some examples, based on a determination by instructions 124 that the requesting entity is authorized, instructions 126 may determine an appropriate hypervisor manager instance to receive API call 180 based on one or more of: the identity, attributes, and associations of the requesting entity; which hypervisor manager instance manages a computing resource indicated in or associated with the hypervisor manager native API call 180; or the like. In such examples, instructions 126 may make this determination based on at least one of: information stored by API gateway 121 and information stored in remote sources of information (as described elsewhere herein). In such examples, instructions 126 may replace the spoofed hypervisor manager location identifier with a valid location identifier for the determined hypervisor manager instance (e.g., hypervisor manager 150).

In examples described herein, the format of a hypervisor manager native API call may include the protocol in which the API call is expressed (e.g., SOAP (Simple Object Access Protocol), or the like), the language in which the API call is expressed (e.g., XML (extensible markup language), or the like), and the like. In such examples, providing the hypervisor manager native API call 180 to the hypervisor manager 150 in the same format as when the API call 180 was received by API gateway 121 may include providing the hypervisor manager native API call 180 to the hypervisor manager 150 expressed in the same protocol and the same language as when it was received by API gateway 121. In examples described herein, the API signature of a hypervisor manager native API call may include the function name and the number, order, and respective types of the parameters of the hypervisor manager native API call. In such examples, providing the hypervisor manager native API call 180 to the hypervisor manager 150 with the same API signature as when the API call 180 was received by API gateway 121 may include providing the hypervisor manager native API call 180 to the hypervisor manager 150 with the same function name and the same number, order, and respective types of parameters as hypervisor manager native API call 180 when it was received by API gateway 121. In examples described herein, an hypervisor manager native API call 180 acquired by API gateway 121 is not translated by API gateway 121 to a native API call of native API 155 of hypervisor manager 150, but is instead acquired by API gateway 121 as an API call native to hypervisor manager 150, and provided to hypervisor manager 150 in the same format and with the same API signature as when it was acquired by API gateway 121 (when authorized, as determined by instructions 124).

In some examples, API gateway 121 may hide actual login credentials for hypervisor manager 150 from requesting entities (e.g., as an additional protection for the hypervisor manager 150 in a multi-tenant cloud computing environment). In some examples, instructions 126 of API gateway 121 may provide spoofed hypervisor manager credential(s) to a requesting entity prior to receipt of the API call 180 by API gateway 121, and may maintain a repository associating the spoofed hypervisor manager credential(s) to the actual (i.e., valid) hypervisor manager credential(s) for hypervisor manager 150.

In such examples, the request intercepted by instructions 122 may include spoofed hypervisor manager credential(s) and a spoofed hypervisor manager location identifier in a header of the request and include the hypervisor manager native API call 180 in the body of the request, for example. In such examples, based on a determination by instructions 124 that the requesting entity is authorized to perform the requested action on the computing resource managed by hypervisor manager 150, instructions 126 may obtain an actual (i.e., valid) hypervisor manager location identifier (as described above) and may obtain actual (i.e., valid) hypervisor manager credential(s) that may be used to access the determined hypervisor manager instance. In such examples, instructions 126 may replace the spoofed hypervisor manager credential(s) with the obtained valid hypervisor manager credential(s) and replace the spoofed hypervisor manager location identifier with the obtained valid hypervisor manager location identifier, to generate a modified request including the valid hypervisor manager credential(s) and location identifier (e.g., in a header of the modified request), and including the hypervisor manager native API call 180 (e.g., in a body of the modified request). In such examples, instructions 126 may provide the modified request from API gateway 121 to hypervisor manager 150 at the location identified by the valid hypervisor manager location identifier (e.g., URL).

After providing the hypervisor manager native API call 180 to hypervisor manager 150, hypervisor manager 150 may provide a response back to API gateway 121. This response output by hypervisor manager 150 may be considered a “native” response of the hypervisor manager 150 herein. In some examples, instructions 122 of API gateway 121 may intercept the native response from hypervisor manager 150 (i.e., in response to hypervisor manager native API call 180), and instructions 124 of API gateway 121 may filter (e.g., remove, replace, otherwise obfuscate, etc.) each element of the native response that the requesting entity is not authorized to access, to generate a filtered native response. In such examples, instructions 126 of API gateway 121 may provide the filtered native response from API gateway 121 to a remote computing device 102 of the requesting entity. In some examples, instructions 124 may use at least one of information stored locally on computing device 100 and information stored in one or more remote information sources (as described above) to determine which information in the response the requesting entity is authorized to access or view (and may remain in the response), and which information the requesting entity is not authorized to access or view (and is to be filtered by instructions 126). Based on the determinations of instructions 124, instructions 126 may filter out the appropriate information from the native response to generate the filtered native response.

As described above, instructions 124 of API gateway 121 may determine, based on at least one restriction not enforced by the hypervisor manager, whether a requesting entity associated with the hypervisor manager native API call 180 is authorized to cause an action on (e.g., cause a change to) a computing resource managed by hypervisor manager 150, where the action is requested in the hypervisor manager native API call 180. This determination may be based on any suitable combination of one or more validation check(s) described herein. In such examples, in response to a determination by instructions 124 that at least one of the validation check(s) of the determined series (or pipeline) of validation check(s) fail, instructions 124 may determine that the requesting entity associated with the hypervisor manager native API call 180 is not authorized to perform the requested action on the computing resource managed by hypervisor manager 150.

In such examples, based on a determination by instructions 124 that the requesting entity is not authorized to perform the requested action on the computing resource managed by hypervisor manager 150, based on a restriction not enforced by the hypervisor manager, instructions 126 may provide a denial message, from API gateway 121 to a remote computing device 102 associated with the requesting entity, in the form of an emulated native response from hypervisor manager 150. In examples described herein, an emulated native response from a hypervisor manager is a response generated by API gateway 121 (e.g., instructions 126) that emulates the format and content of a native response from the hypervisor manager. For example, instructions 126 may generate the denial message emulating a native response of hypervisor manager 150 to use a protocol and language used by native responses of hypervisor manager 150, and using content (e.g., text, data, error codes, error messages, other text, other data, etc.) used by hypervisor manager 150 in actual responses (e.g., denial or error responses) from hypervisor manager 150.

In examples described herein, a denial message in the form of an emulated native response from hypervisor manager 150 may be generated and provided by instructions 126 based on a determination by instructions 124 that any one or more of a permissions-related validation check, a capacity-related validation check, an orchestration-related validation check, and a restricted-action related validation check failed. For example, instructions 126 may provide a denial message in the form of an emulated native response from hypervisor manager 150 from API gateway 121 to remote computing device 102 associated with the requesting entity, in response to a determination that a requested action is not permitted to be invoked via a hypervisor manager native API call via API gateway 121, as described above. In examples described herein, the emulated native responses of hypervisor manager 150 are generated by API gateway 121, and are not (modified or unmodified) responses from hypervisor manager 150.

In examples described herein, any hypervisor manager (such as hypervisor manager 150) may be a particular instance of a hypervisor manager of a particular type, where the cloud computing environment including the hypervisor manager instance may include multiple instances of a hypervisor manager of the particular type. In such examples, API gateway 121 may transparently (to a requesting entity) select an appropriate hypervisor manager instance for a hypervisor manager native API call from the requesting entity. In such examples, based on a determination by instructions 124 that the action requested in API call 180 is authorized (as described above), instructions 126 may determine an appropriate hypervisor manager instance to provide the hypervisor manager native API call 180 to. In some examples, as described above, a hypervisor manager native API call 180 may be acquired from remote computing device 102 as part of a request that also includes a spoofed hypervisor manager location identifier and spoofed hypervisor manager credential(s). In such examples, the spoofed hypervisor manager location identifier may serve as a single location identifier that a requesting entity may use with hypervisor manager native API calls for a particular type of hypervisor manager, though the cloud computing environment may actually include multiple hypervisor manager instances of the particular type, each at a location represented by a different location identifier (e.g., URL). In such examples, for each acquired hypervisor manager native API call that is determined to be authorized, instructions 126 may determine the appropriate hypervisor manager instance to receive that hypervisor manager native API call, and provide it to the appropriate instance. In such examples, instructions 126 may determine the appropriate hypervisor manager instance based on a number of factor(s) such as one or more of: the identity, attributes, and associations of the requesting entity; which hypervisor manager instance manages a computing resource indicated in or associated with the hypervisor manager native API call; or the like. For example, some hypervisor manager instance(s) may be dedicated to a particular tenant while other hypervisor manager instance(s) may be shared among multiple tenants, and instructions 126 may route an API call from a requesting entity belonging to a particular tenant to an appropriate hypervisor manager instance dedicated to or shared by that tenant.

For example, for a hypervisor manager native API call requesting to take an action on a previously created computing resource, instructions 126 may determine which hypervisor manager instance manages that computing resource and select that instance as the appropriate instance to provide the API call to. As another example, for a hypervisor manager native API call requesting to create a computing resource (e.g., virtual machine), instructions 126 may determine the appropriate hypervisor manager instance based on permissions associated with the requesting entity (e.g., one or more of the identity, attribute(s), and association(s) of the requesting entity), so that the computing resource is created on resources of the cloud computing environment that the requesting entity has permission to access and via a hypervisor manager instance that the requesting entity has access to (e.g., executing in a data center that the requesting entity has access to). In such examples, instructions 126 may make this determination based on at least one of: information stored by API gateway 121 and information stored in remote sources of information (as described elsewhere herein). In some examples, after instructions 126 determines the appropriate hypervisor manager instance, instructions 126 may replace the spoofed hypervisor manager location identifier of the request including hypervisor manager native API call 180 with the actual (i.e., valid) hypervisor manager location identifier (e.g., URL) of the determined hypervisor manager instance to generate a modified request including the API call 180 (as described above), and provide the modified request to the determined hypervisor manager instance. In some examples, instructions 126 may also replace spoofed hypervisor manager credential(s) with actual (i.e., valid) hypervisor manager credential(s) for the determined hypervisor manager instance. Although several examples are described herein in the context of taking action(s) on existing computing resource(s) via a hypervisor manager (e.g., hypervisor manager instance), in other examples, requesting entities may also create new computing resource(s) via hypervisor manager native API calls in a manner similar to what is described herein in relation to other examples. In examples described herein, an API gateway may intercept and route hypervisor manager native API calls to appropriate hypervisor manager instances using context (e.g., at least one of: requesting entity identity, attribute(s), and association(s), and computing resource attribute(s) and association(s)) and policies in a manner that is transparent to a requesting entity. In some examples, an API gateway may also intercept network and storage manager native API calls (as described below) and route them to appropriate network or storage manager instances in a similar manner.

As used herein, a “computing device” may be a desktop or laptop computer, switch, router, server, or any other processing device or equipment including a processing resource. In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 110 may fetch, decode, and execute instructions stored on storage medium 120 to perform the functionalities described above in relation to instructions 122, 124 and 126. In other examples, the functionalities of any of the instructions of storage medium 120 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the example of FIG. 1, storage medium 120 may be implemented by one machine-readable storage medium, or multiple machine-readable storage media.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

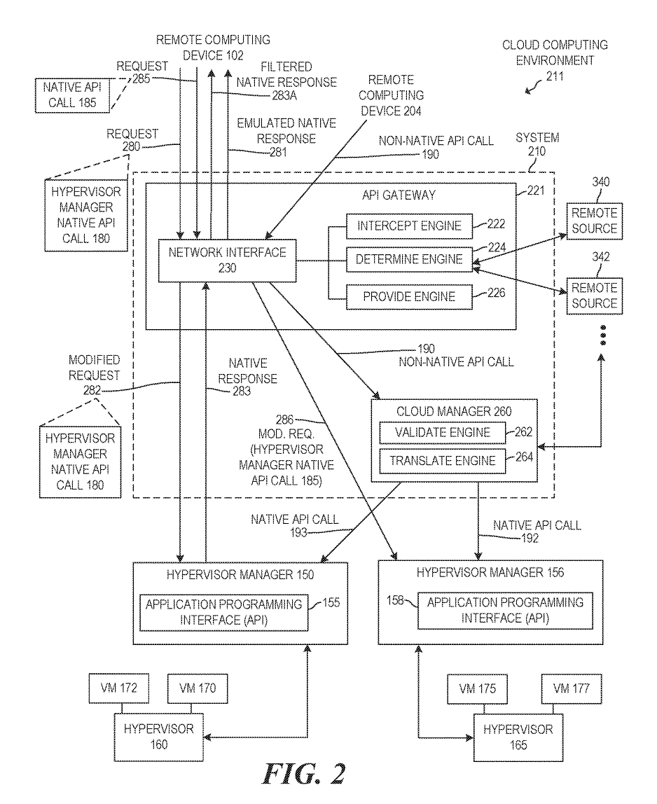

In some examples, instructions 122, 124, and 126 may be part of an installation package that, when installed, may be executed by processing resource 110 to implement the functionalities described above. In such examples, storage medium 120 may be a portable medium, such as a CD, DVD, or flash drive, or a memory maintained by a server from which the installation package can be downloaded and installed. In other examples, instructions 122, 124, and 126 may be part of an application, applications, or component(s) already installed on computing device 100 including processing resource 110. In such examples, the storage medium 120 may include memory such as a hard drive, solid state drive, non-volatile memory device, or the like. In some examples, functionalities described herein in relation to FIG. 1 may be provided in combination with functionalities described herein in relation to any of FIGS. 2-5.

FIG. 2 is a block diagram of an example cloud computing environment 221 including an API gateway 221 to provide, to a hypervisor manager 150, a modified request 282 including a received hypervisor manager native API call 180. In the example of FIG. 2, cloud computing environment 221 includes a system 210 comprising API gateway 221. API gateway 221 may be implemented by at least one computing device and may include at least one network interface 230, which may be a networking device to communicate with other computing resource(s) (e.g., computing device(s)) via at least one computer network. In examples described herein, a computer network may include, for example, a local area network (LAN), a virtual LAN (VLAN), a wireless local area network (WLAN), a virtual private network (VPN), the Internet, or the like, or a combination thereof. In the example of FIG. 2, API gateway 221 further includes engines 222, 224, and 226, which may be any combination of hardware and programming to implement the functionalities of the engines, as described herein. In some examples, intercept engine 222 may perform any of the functionalities described above in relation to instructions 122, determine engine 224 may perform any of the functionalities described above in relation to instructions 124, and provide engine 226 may perform any of the functionalities described above in relation to instructions 126. In some examples, system 210 may further include a cloud manager 260, as illustrated in FIG. 2. In other examples, system 210 may not include the cloud manager 260. Cloud computing environment 211 may also include a remote computing device 102 and a hypervisor manager 150, as described above in relation to FIG. 1. Hypervisor manager 150 may expose a native API 155, as described above, and may manage various computing resources including, for example, a hypervisor 160 and virtual machines 170 and 172 to be run by hypervisor 160.

In the example of FIG. 2, network interface 230 may acquire, from a remote computing device 102 associated with a requesting entity, a request 280 including hypervisor manager native API call 180 native to hypervisor manager 150, as described above. The hypervisor manager native API call 180 may have a format that is valid to invoke of at least one action of given hypervisor manager 150, via the API 155 exposed by hypervisor manager 155, when hypervisor manager native API call 180 is provided to hypervisor manager 150, as described above. In such examples, intercept engine 222 of API gateway 221 may intercept the hypervisor manager native API call 180, as described above in relation to instructions 122 of FIG. 1.

In the example of FIG. 2, intercept engine 222 may acquire (e.g., receive, retrieve, etc.) hypervisor manager native API call 180 via network interface 230 of API gateway 221 a request (or request packet) that includes the API call 180 as well as other information, such as another header (e.g., a request header) separate from the API call 180 and including, for example, hypervisor manager credential(s) and a hypervisor manager location identifier, as described above. In some examples, the hypervisor manager credential(s) and hypervisor manager location identifier may each be spoofed, as described above. After acquiring the request including API call 180, engine 222 may identify the API call 180 as a hypervisor manager native API call, as described above in relation to instructions 122 of FIG. 1. For example, engine 222 may compare the signature of API call 180 (e.g., the function name and the number, order, and types of the parameters of the API call) to other API call signature information (e.g., stored in memory 120, elsewhere on computing device 100, or outside of computing device 100) for use in identifying hypervisor manager native API calls, as described above. In the example of FIG. 2, in which API call 180 is a hypervisor manager native API call 180, engine 222 may identify API 180 as a hypervisor manager native API call, as described above, which may trigger a validation process associated with the identified hypervisor manager native API call that may delay the provision of the hypervisor manager native API call 180 to the appropriate hypervisor manager 150 until after a validation (of determine engine 224) successfully completes, as described above in relation to FIG. 1.

In some examples, the identification of API call 180 as a hypervisor manager native API call may trigger a determination process of determine engine 224, which may include performing a series (or pipeline) of one or more validation checks based on the particular hypervisor manager native API call 180 identified by engine 222. For example, engine 224 may perform the series of validation check(s) in response to engine 222 identifying API call 180 as a hypervisor manager native API call.

In the example of FIG. 2, in response to engine 222 identifying API call 180 as a hypervisor manager native API call, engine 224 of API gateway 221 may determine whether a requesting entity associated with hypervisor manager native API call 180 is authorized to cause an action on (e.g., cause a change to) a computing resource managed by the hypervisor manager 150, wherein the action (e.g., change) is requested in the hypervisor manager native API call 180. In the example of FIG. 2, this determination may be based on at least one restriction not enforced by hypervisor manager 150. In examples described herein, the series of validation checks performed by engine 224 of API gateway 221 may be performed as part of the enforcement, by API gateway 221, of restriction(s) that are not enforced by hypervisor manager 150, as described above.

In some examples, as part of the authorization determination, engine 224 may determine a requesting entity associated with the hypervisor manager native API call 180 based on user information provided in request 280 in which hypervisor manager native API call 180 was acquired. For example, request 280 may include hypervisor manager native API call 180 and requestor information in header information of the request (which is separate from API call 180). As an example, the requestor information may include authentication information (e.g., an authentication or session identifier, cookie, token, or the like), which engine 224 may use to determine a user identity for the requesting entity. For example, engine 224 may access a repository maintained by API gateway 221 (e.g., stored in memory API gateway 221 or elsewhere), in which authentication information (or session information) is associated with respective user identities, and may determine a user identity corresponding to the authentication information provided in the header of request 280. Engine 224 may then use the determined user identity associated with the session information for the validation check(s). In some examples, the authentication information provided in the header of request 280 may be the same as spoofed hypervisor manager credential(s) described elsewhere herein.

In some examples, as part of the authorization determination, engine 224 may determine a computing resource that is a subject of the validation check(s) from the content of the API call 180, which may include an identifier for the computing resource. For example, in the example API call 180 described above, the API call 180 may include the virtual machine identifier VM-101 as a parameter, and engine 224 may determine, by inspecting API call 180, that virtual machine identifier VM-101 identifies a computing resource (e.g., VM 170) that is a subject of the validation checks.

In some examples, engine 224 may perform different series (or pipelines) of validation check(s) for different types of hypervisor manager native API calls (e.g., hypervisor manager native APIs call with different signatures), respectively, as described above in relation to instructions 124. In such examples, as part of the authorization determination, engine 224 may determine the series (or pipeline) of validation check(s) to perform as part of the authorization determination, based on the signature of hypervisor manager native API call 180, as described above. In such examples, engine 224 may perform the determined series (or pipeline) of validation check(s). When performing the validation check(s), engine 224 may access remote information sources 340, 342, etc., external to API gateway 221, to obtain and use current information regarding the identities, attributes, associations, and the like, of the requesting entity and the computing resource. As described above, these remote information sources 340, 342, etc., may include one or more of resource management database(s) or system(s) (e.g., indicating permissions, attributes, associations, or the like, for entities and computing resources), a cloud service provider system (e.g., accessible via a cloud service provider API), an authentication system, and the like, each of which may be remote from API gateway 221.

For example, engine 224 may access a remote information source 340 including resource management information for managing different access permissions for different tenants in a multi-tenant cloud computing environment, wherein different access permissions for different tenants are not enforced by hypervisor manager 150. In such examples, engine 224 may determine whether the requesting entity is authorized to cause a change requested in API call 180 based (at least in part) on information accessed from the remote information source. For example, engine 224 may access one or more of the identity, attributes, associations (e.g., role(s), membership(s), etc.), and the like, of the requesting entity or computing resource associated with API call 180, and engine 224 may use this information to perform multi-tenancy related validation check(s) relates to whether the requesting entity is authorized to perform requested action(s) on the computing resource associated with the API call 180, as described above in relation to FIG. 1.

In the example of FIG. 1, engine 224 may determine that the requesting entity associated with hypervisor manager native API call 180 is authorized to cause the requested action on (e.g., cause the requested change to) the identified computing resource managed by the hypervisor manager 150 when engine 224 determines that all of the validation check(s) of the determined series (or pipeline) were passed successfully. In such examples, engine 224 may determine that the requesting entity associated with hypervisor manager native API call 180 is not authorized to cause the requested action on (e.g., cause the requested change to) the identified computing resource managed by the hypervisor manager 150 when engine 224 determines that at least one of the validation check(s) of the determined series (or pipeline) fails. In some examples, the determination process of engine 224 may include a series (or pipeline) of validation check(s) that includes permissions-related validation check(s), capacity-related validation check(s), orchestration-related validation check(s), and restricted-action validation check(s), as described above, or a combination thereof.

In the example of FIG. 2, based on any suitable combination of one or more validation check(s) described herein, engine 224 API gateway 221 may determine, based on at least one restriction not enforced by the hypervisor manager, whether a requesting entity associated with the hypervisor manager native API call 180 is authorized to cause an action on (e.g., cause a change to) a computing resource managed by hypervisor manager 150, where the action is requested in the hypervisor manager native API call 180. In such examples, in response to a determination that all validation check(s) of the determined series (or pipeline) of validation check(s) have passed, engine 224 may determine that the requesting entity associated with the hypervisor manager native API call 180 is authorized to perform the requested action on the computing resource managed by hypervisor manager 150 (e.g., VM 170).

In such examples, based on a determination that the requesting entity is authorized to perform the requested action on the computing resource managed by hypervisor manager 150, engine 226 may provide a modified request 282 from API gateway 221 to hypervisor manager 150, where the modified request 282 includes the hypervisor manager native API call 180 in the same format, and with the same API signature, as when the API call 180 was acquired by API gateway 221.

Based on a determination by instructions 124 that the requesting entity is authorized to perform the requested action on the computing resource managed by hypervisor manager 150, instructions 126 may forward the hypervisor manager native API call 180 from the API gateway to the hypervisor manager in the same format and with the same API signature as when it was received at the API gateway. In some examples, to forward the API call 180, instructions 126 may determine a location of the hypervisor manager 150 (i.e., the hypervisor manager instance) to which the API call 180 is to be provided, and provide the API call 180 to the hypervisor manager 150 at the determined location.

As described above in relation to FIG. 1, as protection for the hypervisor manager 150 in a multi-tenant cloud computing environment, API gateway 221 may hide an actual location identifier (e.g., uniform resource locator (URL)) of hypervisor manager 150 from requesting entities and may hide actual hypervisor manager credential(s) useable to log in to (or otherwise gain access to) hypervisor manager 150 from requesting entities. In such examples, engine 226 of API gateway 221 may provide a spoofed hypervisor manager location identifier and spoofed hypervisor manager credential(s) to a requesting entity prior to receipt of the API call 180 by API gateway 221. In some examples, a collection of actual hypervisor manager location identifiers and actual hypervisor manager credentials may be maintained on API gateway 221, in at least one of remote sources of information 340, 342, etc., or a combination thereof. In such examples, engine 226 may determine appropriate hypervisor manager location identifiers and credentials to replace spoofed hypervisor manager location identifiers and credentials may be performed as described above in relation to instructions 126.

In such examples, the request 280 intercepted by engine 222 may include spoofed hypervisor manager credential(s) and a spoofed hypervisor manager location identifier in a header of request 280 and include the hypervisor manager native API call 180 in the body of request 280, for example. In such examples, based on a determination by engine 224 that the requesting entity is authorized to perform the requested action on the computing resource managed by hypervisor manager 150, engine 226 may obtain an actual hypervisor manager location identifier and may obtain actual hypervisor manager credential(s) (as described above in relation to instructions 126). In such examples, engine 226 may replace the spoofed hypervisor manager credential(s) with the obtained valid hypervisor manager credential(s) and replace the spoofed hypervisor manager location identifier with the obtained valid hypervisor manager location identifier, to generate a modified request 228 including the valid hypervisor manager credential(s) and location identifier in a header of the modified request 282, and including the hypervisor manager native API call 180 in a body of the modified request 282. In such examples, engine 226 may determine the destination address for the modified request 282 based on the obtained actual hypervisor manager location identifier (e.g., URL), and may provide the modified request 282 from API gateway 221 to hypervisor manager 150 at the location identified by the valid hypervisor manager location identifier. In some examples, engine 226 may provide the modified request 282 to hypervisor manager 150 via network interface 230.

After the hypervisor manager native API call 180 is provided to hypervisor manager 150, hypervisor manager 150 may act on it and provide a native response 283 back to API gateway 221. In some examples, engine 222 of API gateway 221 may intercept the native response 283 from hypervisor manager 150, and engine 224 of API gateway 221 may filter (e.g., remove, replace, otherwise obfuscate, etc.) each element of native response 283 that the requesting entity is not authorized to access, to generate a filtered native response 283A, as described above in relation to FIG. 1. In such examples, engine 226 of API gateway 221 may provide the filtered native response 283A from API gateway 221 to a remote computing device 102 of the requesting entity (e.g., via network interface 230).

In other examples, in response to a determination by engine 224 that at least one of the validation check(s) of the determined series (or pipeline) of validation check(s) fails, engine 224 may determine that the requesting entity associated with the hypervisor manager native API call 180 is not authorized to perform the requested action on the computing resource managed by hypervisor manager 150. In such examples, based on a determination by engine 224 that the requesting entity is not authorized to perform the requested action on the computing resource managed by hypervisor manager 150 (based on a restriction not enforced by the hypervisor manager), engine may provide a denial message, from API gateway 221 to a remote computing device 102 associated with the requesting entity, in the form of an emulated native response 281 from hypervisor manager 150. In the example of FIG. 2, the emulated native response 281 is generated by API gateway 221 (e.g., engine 226) and emulates the format and content of a native response from hypervisor manager 150, as described above in relation to FIG. 1. In examples described herein, a denial message in the form of an emulated native response 281 from hypervisor manager 150 may be generated and provided by engine 226 based on a determination by engine 224 that any one or more of a permissions-related validation check, a capacity-related validation check, an orchestration-related validation check, and a restricted-action related validation check failed.

In some examples, API gateway 221 may be able to perform validation check(s) and selectively pass through hypervisor manager native API calls for multiple different types of hypervisor managers having different and incompatible native APIs. For example, in the example of FIG. 2, cloud computing environment 211 may include hypervisor manager 150 exposing an API 155 native to hypervisor manager 150, and may include a hypervisor manager 156 exposing an API 156 native to hypervisor manager 156 and managing computing resource (e.g., hypervisor 165 to run VMs 175 and 177). In the example of FIG. 2, hypervisor managers 150 and 156 are of different types (e.g., one may be for use with VMware®, and the other may be for use with MICROSOFT HYPER-V), and their respective native APIs 155 and 158 are different. In such examples, hypervisor manager native API calls valid for API 155 are not valid to invoke any action of hypervisor manager 156 (e.g., via API 158), and hypervisor manager native API calls valid for API 158 are not valid to invoke any action of hypervisor manager 150 (e.g., via API 155). In such examples, API gateway 221 may acquire and process request 280, including hypervisor manager native API call 180, as described above for hypervisor manager 150. In such examples, API gateway 221 may further acquire, via network interface 230, another request 285 including another API call 185 that is native to hypervisor manager 156 of cloud computing environment 221. In such examples, hypervisor manager native API call 185 is not native to hypervisor manager 150 (e.g., not valid to invoke action(s) of hypervisor manager 150, as described above), and API call 180 native to hypervisor manager 150 is not native to hypervisor manager 156 (e.g., not valid to invoke action(s) of hypervisor manager 156, as described above). In such examples, engine 224 may determine whether hypervisor manager native API call 185 is authorized, as described above in relation to hypervisor manager native API call 180. In such examples, based on a determination that native hypervisor API call 185 is authorized, engine 226 provide a modified request 286, from API gateway 221 to hypervisor manager 156. In such examples, the modified request 286 may include hypervisor manager native API call 185 in the same format, and with the same API signature, in which it was acquired by API gateway 221, and different information in a header of the request to replace spoofed information (as described above in relation to request 280 and modified request 282).

In some examples, API gateway 221 may be able to provide mixed-mode access to computing resources of cloud computing environment 221. For example, API gateway 221 may provide access to hypervisor managers, for example, both via hypervisor manager native API calls acquired at the API gateway 221 from requesting entities, and via abstracted API calls (e.g., non-native API calls that are not native to any hypervisor manager) which may be translated before being provided to a respective hypervisor manager. In such examples, API gateway 221 providing mixed-mode access to computing resources may provide more flexibility for clients to access computing resources of cloud computing environment 211 in a desired manner. For example, native APIs may provide a benefit of being fine-grained but may involve more programming sophistication to utilize, while non-native APIs may enable communication via coarser-grained and relatively simpler interactions but with less precise control in some examples.

In some examples, network interface 230 may acquire, from a remote computing device 204, a non-native API call 190 that is not native to any hypervisor manager of cloud computing environment 211, such that non-native API call 190 is not valid to invoke any action by any hypervisor manager of cloud computing environment 211 (when provided to any such hypervisor manager). In such examples, engine 226 may provide the non-native API call 190 to cloud manager 260, which may be implemented by at least one computing device including engines 262 and 264, which may be any combination of hardware and programming (as described below) to implement the functionalities of the engines described herein. In such examples, validate engine 262 of cloud manager 260 may determine whether the action requested in the non-native API call 190 is authorized, as described above in relation to engine 224 and instructions 124. For example, engine 262 may access remote sources of information 340, 342, etc., to make this determination. Based on (or in response to) a determination by engine 262 that the non-native API call 190 is authorized, translate engine 264 of cloud manager 260 may translate the non-native API call 190 to a native API call 192 or 193 having a format and API signature native to a selected hypervisor manager 156 or 150 of cloud computing environment 221 and may provide the translated API call 192 or 193 to the selected hypervisor manager 156 or 150. For example, engine 264 may translate the non-native API call 190 into either a hypervisor manager native API call 192 for hypervisor manager 156, or into a hypervisor manager native API call 193 for hypervisor manager 150, depending on the hypervisor manager target of the non-native API call, as determined by cloud manager 260 from the non-native API call 190.

API gateway 221 may include at least engines 222, 224, and 226, which may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of API gateway 221. In some examples, the at least one machine-readable storage medium may store instructions that, when executed by the at least one processing resource, at least partially implement some or all engines of API gateway 221. In such examples, API gateway 221 may include the at least one machine-readable storage medium storing the instructions and the at least one processing resource to execute the instructions. In some examples, engines 222, 224, and 226 may be implemented as processing resource 110 and instructions 122, 124, and 126 stored on memory 120 (as shown an described above in relation to FIG. 1).

In some examples, the instructions can be part of an installation package that, when installed, can be executed by the at least one processing resource to at least partially implement at least some of the engines of API gateway 221. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on networking device 200 including the processing resource. In such examples, the machine-readable storage medium may include memory such as a hard drive, solid state drive, or the like. In other examples, the functionalities of any engines of API gateway 221 may be at least partially implemented in the form of electronic circuitry. In some examples, functionalities described herein in relation to FIG. 2 may be provided in combination with functionalities described herein in relation to any of FIGS. 1 and 3-5.

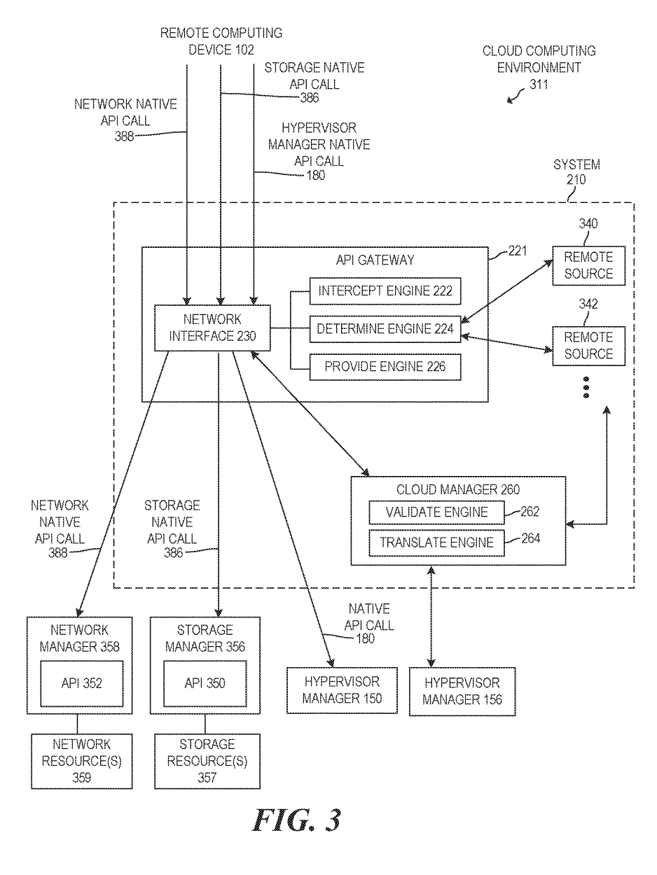

FIG. 3 is a block diagram of an example cloud computing environment 311 including an API gateway 221 to provide network and storage native API calls 388, 386 to network and storage managers 358, 356, respectively. In the example of FIG. 3, cloud computing environment 311 includes a system 210, as described above in relation to FIG. 2, including API gateway 221 as described above, cloud manager 260 as described above, and remote information sources 340, 342, etc., as described above. Cloud computing environment 311 also includes hypervisor managers 150 and 156, as described above. In example of FIG. 3, API gateway 221 may intercept, perform validation check(s), and selectively provide to a hypervisor manager based on the validation check(s), as described above in relation to FIGS. 1 and 2.

In the example of FIG. 3, cloud computing environment 311 further comprises a storage manager 356 to manage storage resource(s) 357. Storage manager 356 exposes an API 350 native to storage manager 356. In the example of FIG. 3, network interface 230 of API gateway 221 may acquire a storage manager native API call 386 (which may be referred to as a resource manager native API call 386). In such examples, the storage manager native API call 386 is native to storage manager 356, such that storage manager native API call 386, when provided to storage manager 356, may invoke an action of storage manager 356, via the native API 350 of storage manager 356. In such examples, the API signature of storage manager native API call 386 is consistent with an API signature of an API function defined by API 350. In such examples, engine 224 may determine whether an action requested in the storage manager native API call 386 is authorized, as described above in relation to FIGS. 1 and 2 (e.g., based on at least one restriction not enforced by the storage manager 356). In examples in which engine 224 determines that the action requested in the API call 386 is authorized, engine 226 may provide the storage manager native API call 386 from API gateway 221 to storage manager 356 (to which the API call 386 is native), in the same format, and with the same API signature, in which it was received by API gateway 221. In this way, API gateway 221 may provide for native API call pass-through for a storage manager 356, while providing additional protection (e.g., for multi-tenancy) that are not provided natively by the storage manager 356.

In the example of FIG. 3, cloud computing environment 311 further comprises a network manager 358 to manage network resource(s) 359. Network manager 358 exposes an API 352 native to network manager 358. In the example of FIG. 3, network interface 230 of API gateway 221 may acquire a network manager native API call 388 (which may be referred to as a resource manager native API call 388). In such examples, the network manager native API call 388 is native to network manager 358, such that network manager native API call 388, when provided to network manager 358, may invoke an action of network manager 358, via the native API 352 of network manager 358. In such examples, the API signature of network manager native API call 388 is consistent with an API signature of an API function defined by API 352. In such examples, engine 224 may determine whether an action requested in the network manager native API call 388 is authorized, as described above in relation to FIGS. 1 and 2 (e.g., based on at least one restriction not enforced by the network manager 358). In examples in which engine 224 determines that the action requested in the API call 388 is authorized, engine 226 may provide the network manager native API call 388 from API gateway 221 to network manager 358 (to which the API call 388 is native), in the same format, and with the same API signature, in which it was received by API gateway 221. In this way, API gateway 221 may provide for native API call pass-through for a network manager 358, while providing additional protection (e.g., for multi-tenancy) that are not provided natively by the network manager 358. In the examples described above, each of the network and storage native API calls 388 and 386 may be acquired by API gateway 221 in requests also including spoofed information which may be replaced by API gateway 221 before passing modified requests including the API calls through to the respective network and storage managers, as described above in relation to FIGS. 1 and 2.

Although examples are described herein in relation to one network manager and one storage manager for explanatory purposes, in some examples, cloud computing environment 311 may include one or more network managers and one or more storage managers, which API gateway 221 may interact with as described above in relation to network and storage managers 358 and 356. In some examples, functionalities described herein in relation to FIG. 3 may be provided in combination with functionalities described herein in relation to any of FIGS. 1-2 and 4-5.

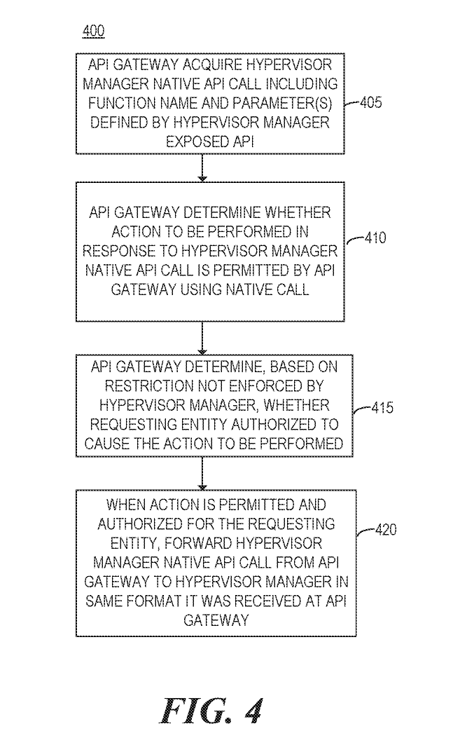

FIG. 4 is a flowchart of an example method 400 of an API gateway including forwarding a hypervisor manager native API call to a hypervisor manager. Although execution of method 400 is described below with reference to API gateway 221 of FIG. 2, other suitable systems for the execution of method 400 may be utilized (e.g., API gateway 121 of computing device 100 of FIG. 1). Additionally, implementation of method 400 is not limited to such examples.

At 405 of method 400, network interface 230 of API gateway 221 may acquire, from a remote computing device 102 associated with a requesting entity, an API call 180 native to a hypervisor manager 150 of a cloud computing environment 221, the hypervisor manager native API call 180 including a function name and one or more parameters defined by an API 155 exposed by hypervisor manager 150 for invocation of a function of the API 155, as described above. In such examples, engine 222 may intercept hypervisor manager native API call 180, as described above. At 410, engine 224 of API gateway 221 may determine whether an action to be performed by the function of the hypervisor manager API in response to the hypervisor manager native API call is permitted by the API gateway to be invoked via the hypervisor manager native API call, as described above in relation to FIG. 1 (e.g., restricted-action related validation check(s)).

At 415, engine 224 of API gateway 221 may determine, based on at least one restriction not enforced by hypervisor manager 150, whether a requesting entity associated with hypervisor manager native API call 180 is authorized to cause the action to be performed, as described above in relation to FIGS. 1 and 2. At 420, when it is determined that the requested action is permitted by the API gateway and authorized for the requesting entity, engine 226 of API gateway 221 may forward the hypervisor manager native API call 180 from the API gateway 221 to hypervisor manager 150 in the same format, and with the same API signature, as when it was received at API gateway 221. Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 4 may be provided in combination with functionalities described herein in relation to any of FIGS. 1-3 and 5.

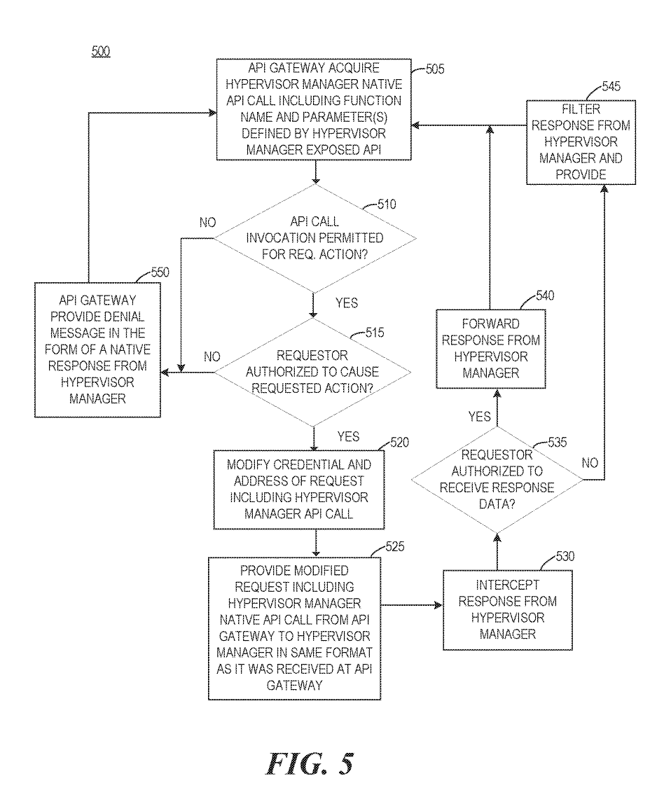

FIG. 5 is a flowchart of an example method of an API gateway including determining whether a requesting entity is authorized to cause an action associated with a hypervisor manager native API call received by the API gateway. Although execution of method 500 is described below with reference to API gateway 221 of FIG. 2, other suitable systems for the execution of method 500 may be utilized (e.g., API gateway 121 of computing device 100 of FIG. 1). Additionally, implementation of method 500 is not limited to such examples.

At 505 of method 500, network interface 230 of API gateway 221 may acquire, from a remote computing device 102 associated with a requesting entity, an API call 180 native to a hypervisor manager 150 of a cloud computing environment 221, the hypervisor manager native API call 180 including a function name and one or more parameters defined by an API 155 exposed by hypervisor manager 150 for invocation of a function of the API 155, as described above. In such examples, engine 222 may intercept hypervisor manager native API call 180, as described above. At 510, engine 224 of API gateway 221 may determine whether an action to be performed by the function of the hypervisor manager API in response to the hypervisor manager native API call is permitted by the API gateway to be invoked via the hypervisor manager native API call, as described above in relation to FIG. 1 (e.g., restricted-action related validation check(s)). If not, then at 550, engine 226 of API gateway 221 may provide a denial message, from the API gateway to the remote computing device, in the form of an emulated native response from the hypervisor manager, as described above in relation to FIGS. 1 and 2. If so, then at 515, engine 224 of API gateway 221 may determine, based on at least one restriction not enforced by hypervisor manager 150, whether a requesting entity associated with hypervisor manager native API call 180 is authorized to cause the action to be performed, as described above in relation to FIGS. 1 and 2. If not, then at 550, engine 226 of API gateway 221 may provide a denial message, from the API gateway to the remote computing device, in the form of an emulated native response from the hypervisor manager, as described above in relation to FIGS. 1 and 2. If so, then at 520, engine 226 may modifying a hypervisor manager credential and a hypervisor manager location identifier of a request 280 including the hypervisor manager native API call 180, as described above, to generate a modified request. At 525, engine 226 may provide the modified request 282 from API gateway 221 to hypervisor manager 150, the modified request 282 including the modified hypervisor manager credential and hypervisor manager location identifier, and including the hypervisor manager native API call 180 in the same format, and with the same API signature, as when it was received at the API gateway.

At 530, engine 222 of API gateway 221 may intercept a native response 283 from hypervisor manager 150 (provided in response to API call 180). At 535, engine 224 may determine which information in the response the requesting entity is authorized to access or view (and may remain in the response), and which information the requesting entity is not authorized to access or view (and is to be filtered by instructions 126), as described above in relation to instructions 124 of FIG. 1. If engine 224 determines that the requesting entity is authorized to access or view all information in native response 283, then at 540, engine 226 may forward the native response 283 from API gateway 221 to remote computing device 102. If engine 224 determines that the requesting entity is not authorized to access or view all information in native response 283, then at 545, engine 224 of API gateway 221 may filter (e.g., remove, replace, otherwise obfuscate, etc.) each element of native response 283 that the requesting entity is not authorized to access, to generate a filtered native response 283A, as described above in relation to FIG. 1, and provide the filtered native response 283A to remote computing device 102 of the requesting entity.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 5 may be provided in combination with functionalities described herein in relation to any of FIGS. 1-4. All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. An article comprising at least one non-transitory machine-readable storage medium comprising instructions, at least partially implementing an application programming interface (API) gateway, the instructions executable by at least one processing resource to:
intercept, with the API gateway, an API call native to a hypervisor manager of a cloud computing environment, the hypervisor manager native API call received at the API gateway from a remote computing device;
determine, with the API gateway and based on at least one restriction not enforced by the hypervisor manager, whether a requesting entity associated with the hypervisor manager native API call is authorized to cause a change, to a computing resource managed by the hypervisor manager, that is requested in the hypervisor manager native API call; and
based on a determination that the requesting entity is authorized, forward the hypervisor manager native API call from the API gateway to the hypervisor manager in the same format and with the same API signature as when it was received at the API gateway.

2. The article of claim 1, wherein the hypervisor manager native API call has a format and API signature that is valid to invoke at least one action of the hypervisor manager, via an API exposed by the hypervisor manager, when the hypervisor manager native API call is provided to the hypervisor manager.

3. The article of claim 2, wherein the hypervisor manager native API call comprises:
a function name defined by the API exposed by the hypervisor manager for invocation of a function exposed by the hypervisor manager via the API; and
a collection of one or more parameters of a number and order, and each of a respective type, defined by the API exposed by the hypervisor manager for the function exposed via the function name.

4. The article of claim 1, wherein:
the hypervisor manager is one of a plurality of hypervisor manager instances of a given type;
the hypervisor manager native API call is intercepted as part of a request comprising the hypervisor manager native API call and a spoofed hypervisor manager location identifier;
the instructions to forward further comprise instructions to:
determine that the hypervisor manager is an appropriate hypervisor manager instance to receive the hypervisor manager native API call;
replace the spoofed hypervisor manager location identifier in the request with a valid hypervisor manager location identifier for the hypervisor manager to generate a modified request including the hypervisor manager native API call and the valid hypervisor manager location identifier; and
provide the modified request from the API gateway to the hypervisor manager.

5. The article of claim 1, wherein the instructions further comprise instructions to:
determine, at the API gateway, that a hypervisor manager action exposed by the hypervisor manager via an API and requested in the hypervisor manager native API call is not an action permitted by the API gateway to be invoked via a hypervisor manager native API call provided via the API gateway, regardless of any permissions associated with the requesting entity and the computing resource; and
in response to the determination that the requested action is not permitted to be invoked via a hypervisor manager native API call via at the API gateway, provide a denial message in the form of an emulated native response from the hypervisor manager from the API gateway to the remote computing device.

6. The article of claim 1, wherein the instructions further comprise instructions to:
in response to a determination that the identified user is not authorized, based on a restriction not enforced by the hypervisor manager, provide a denial message, from the API gateway to the remote computing device, in the form of an emulated native response from the hypervisor manager.

7. The article of claim 1, wherein the instructions further comprise instructions to:
intercept, at the API gateway, a native response to the hypervisor manager native API call from the hypervisor manager;
at the API gateway, filter each element of the native response that the requesting entity is not authorized to access, to generate a filtered native response;
provide the filtered native response from the API gateway to the remote computing device.

8. A system comprising:
an application programming interface (API) gateway comprising:
a network interface to acquire, from a remote computing device, a request including an API call native to a given hypervisor manager of a cloud computing environment and having a format that is valid to invoke of at least one action of the given hypervisor manager, via an API exposed by the given hypervisor manager, when the hypervisor manager native API call is provided to the given hypervisor manager;
a determine engine to determine, based on at least one restriction not enforced by the given hypervisor manager, whether a requesting entity associated with the hypervisor manager native API call is authorized to cause a change, to a computing resource managed by the given hypervisor manager, that is requested in the hypervisor manager native API call; and
a provide engine to, based on a determination that the requesting entity is authorized, provide a modified request from the API gateway to the given hypervisor manager, the modified request including the hypervisor manager native API call in the same format, and with the same API signature, as when it was acquired by the API gateway.

9. The system of claim 8, wherein:
the determine engine is to access a remote information source including resource management information for managing different access permissions for different tenants in a multi-tenant cloud computing environment, wherein different access permissions for different tenants are not enforced by the hypervisor manager; and
the determine engine is to determine whether the requesting entity is authorized to cause the change based on information accessed from the remote information source.

10. The system of claim 8, wherein:
the network interface is to acquire another request including another API call native to another hypervisor manager of the cloud computing environment, wherein the other API call is not native to the given hypervisor manager and the API call native to the given hypervisor manager is not native to the other hypervisor manager; and
wherein the provide engine is further to, based on a determination that the other native hypervisor API call is authorized, provide another modified request, from the API gateway to the other hypervisor manager, the other modified request including the other hypervisor manager native API call in the same format, and with the same API signature, in which it was acquired by the API gateway.

11. The system of claim 8, wherein:
the network interface is to acquire a resource manager native API call that is native to a network or storage manager of the cloud computing environment; and
wherein the provide engine is further to, based on a determination that an action requested in the resource manager native API call is authorized, provide the resource manager native API call from the API gateway to the network or storage manager, to which the resource manager API call is native, in the same format, and with the same API signature, in which it was received by the API gateway.

12. The system of claim 8, further comprising a cloud manager, and wherein:
the network interface is to acquire, from a remote computing device, a non-native API call that is not native to any hypervisor manager of the cloud computing environment;
the provide engine is to provide the non-native API call to the cloud manager; and
the cloud manager is to translate the non-native API call to a native API call having a format and API signature native to a selected hypervisor manager of the cloud computing environment and provide the translated API call to the selected hypervisor manager, based on a determination by the cloud manager that the non-native API call is authorized.

13. A method of an application programming interface (API) gateway comprising:
with the API gateway, acquiring, from a remote computing device, an API call native to a hypervisor manager of a cloud computing environment, the hypervisor manager native API call including a function name and one or more parameters defined by an API exposed by the hypervisor manager for invocation of a function of the API;
with the API gateway, determining whether an action to be performed by the function of the hypervisor manager API in response to the hypervisor manager native API call is permitted by the API gateway to be invoked via the hypervisor manager native API call;
with the API gateway, determining, based on at least one restriction not enforced by the hypervisor manager, whether a requesting entity associated with the hypervisor manager native API call is authorized to cause the action to be performed; and
when it is determined that the action is permitted by the API gateway and authorized for the requesting entity, forwarding the hypervisor manager native API call from the API gateway to the hypervisor manager in the same format and with the same API signature as when it was received at the API gateway.

14. The method of claim 13, wherein the forwarding comprises:
when it is determined that the action is permitted by the API gateway and authorized for the requesting entity:
modifying a hypervisor manager credential and a hypervisor manager location identifier of a request including the hypervisor manager native API call to generate a modified request including the hypervisor manager native API call; and
provide the modified request from the API gateway to the hypervisor manager, the modified request including the hypervisor manager native API call in the same format in which it was received at the API gateway.

15. The method of claim 13, further comprising:
when it is determined that an action requested in another hypervisor manager native API call from the remote computing device is not permitted by the API gateway or not authorized for a respective requesting entity associated with the other hypervisor manager native API call, providing a denial message, from the API gateway to the remote computing device, in the form of an emulated native response from the hypervisor manager.
